(19) United States
(12) Patent Application Publication
(10) Pub. No.: US 2016/0123603 A1
(43) Pub. Date: May 5, 2016

(54) CONTROL SYSTEM FOR VENTILATOR

(71) Applicant: FOREMOST GROUPS, INC., East Hanover, NJ (US)

(72) Inventors: Liang Chou Chen, Randolph, NJ (US); Michael Paitchell, Clifton, NJ (US)

(73) Assignee: FOREMOST GROUPS, INC., East Hanover, NJ (US)

(21) Appl. No.: 14/527,404

(22) Filed: Oct. 29, 2014

(51) Int. Cl. F24C 15/20; F21V 33/00

(52) U.S. Cl. CPC F24C 15/2042; F21V 33/0092

(57) ABSTRACT

A ventilator for a stove includes a fan with a motor, and a microprocessor controller that regulates the speed of the fan motor. The controller has a first input from a wireless receiver with a remote control, and a second input from a rotatable local control knob with a rotary encoder. Signals received from the remote control and the rotary encoder indicate whether to increase or decrease the power supplied to the fan, and by how much.

### FIELD OF THE INVENTION

The invention relates to extractors for air in kitchens, and especially to a system for controlling the fan operation of a ventilator in a hood over a cooking stove or the like.

### BACKGROUND

It is well known to provide a hood over a cooking stove or the like in a building, with a vent to the exterior of the building, and a ventilator fan to expel air through the vent. Such a device can be used to collect and expel air laden with excess moisture, smoke, smells, or other emissions from cooking. However, many conventional ventilators have little control over the amount of air that is expelled or the operation of the fan itself. Many conventional systems merely have a single-speed fan with an on-off switch. Such systems result either in a ventilator that is not powerful enough to extract all the fumes at high emission levels, or in a ventilator that is too powerful at low emission levels, or both. The first permits excess smoke, cooking smells, or other emissions to escape into the building, so that the extractor fails to do its job. The second wastes energy, especially in a heated or air-conditioned building, where the ventilator is expelling expensively heated or cooled air.

In recent years multi-speed ventilator units have been developed that permit the fan to be controlled so as to permit different fan speeds. In such systems, the fan motor includes multiple windings and a control knob or switches with several “on” positions. Each setting of the knob/switch energizes different windings, and supplies a different amount of power to the fan motor, thus controlling its speed.

Conventional systems have the disadvantage that the user must physically turn a knob or activate a switch on the unit in order to regulate the speed of the fan or lighting.

There is a need for an improved control system for ventilator units.

### SUMMARY

According to an embodiment, a ventilator for a hood over a stove comprises a fan, a controller that is operative to regulate a speed of the fan, a receiver that is operative to receive wireless signals and to provide a first signal providing information from a received wireless signal as a first input to the controller, and a manipulable control that is operative to provide a second signal indicative of manipulation of the control as a second input to the controller, and in operation the controller monitors the first and second inputs, and if the first or second signal is received, increases or decreases the speed of the fan.

According to another embodiment, a control system is provided for controlling operation of a ventilator for a hood over a stove, the ventilator including a fan. The control system comprises a controller that is operative to regulate an operating speed of the fan, a wireless receiver operative to receive a wireless signal from a remote controller, and to provide a first signal to the controller indicative of the wireless signal, and a manipulable input control operative to provide a second signal to the controller, the second signal being indicative of manipulation of the input control, and the controller is programmed to receive the first and second signals, and to change the speed of the fan upon receiving the first or second signal.

The controller may be programmed to interpret each of the first and second signals as indicating whether to increase or decrease the speed of the fan, and how far to change the speed of the fan. The controller may be programmed to respond to either the first or the second signal irrespective of whether its previous state was set by the first signal or the second signal.

The ventilator may further comprise one or more environmental sensors, such as temperature and/or smoke sensors, and the controller may be programmed to respond to predetermined environmental conditions by setting the fan to a speed that overrides a speed set in response to the first or second signal.

The controller may be programmed to set the fan to one of an off state and a plurality of speeds other than the off state.

The controller may include a microprocessor.

The wireless signals may be radio signals.

The manipulable control may be a rotatable control knob with a rotary encoder operative to provide the second input indicating a sense in which the knob is rotated and how far the knob is rotated.

The ventilator or control system may further comprise a remote control operative to transmit the wireless signals that can be received by the wireless receiver.

The ventilator may further comprise lighting for illuminating a work area below the ventilator, and the remote control may be operative to transmit, and the wireless receiver be operative to receive, commands to control the lighting.

The ventilator may be combined with a hood arranged to be mounted over a stove, wherein the ventilator is dimensioned to be mounted within the hood, with an air intake of the ventilator being positioned within an open lower end of the hood and an air outlet of the ventilator connectable to an exhaust duct leading through an upper end of the hood.

The hood may be permeable to the wireless signals.

The hood may be made of wood, and the wireless signals may be radio signals.

The ventilator may comprise a metal housing, with the wireless receiver within the housing, and the housing may then have a window of material permeable to the wireless signals but not permeable to air.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is a general view of a ventilator hood installed over a cooking stove.

FIG. 2 is a perspective view of a hood ventilator.

FIG. 3 is a bottom view of the ventilator shown in FIG. 2.

FIG. 4 is a schematic of components of the ventilator shown in FIG. 2.

FIG. 5 is a schematic similar to FIG. 4 of an alternative embodiment of ventilator.

### DETAILED DESCRIPTION OF THE EMBODIMENTS

A better understanding of various features and advantages of the present methods and devices may be obtained by reference to the following detailed description of illustrative embodiments of the invention and accompanying drawings. Although these drawings depict embodiments of the contemplated methods and devices, they should not be construed as foreclosing alternative or equivalent embodiments apparent to those of ordinary skill in the subject art.

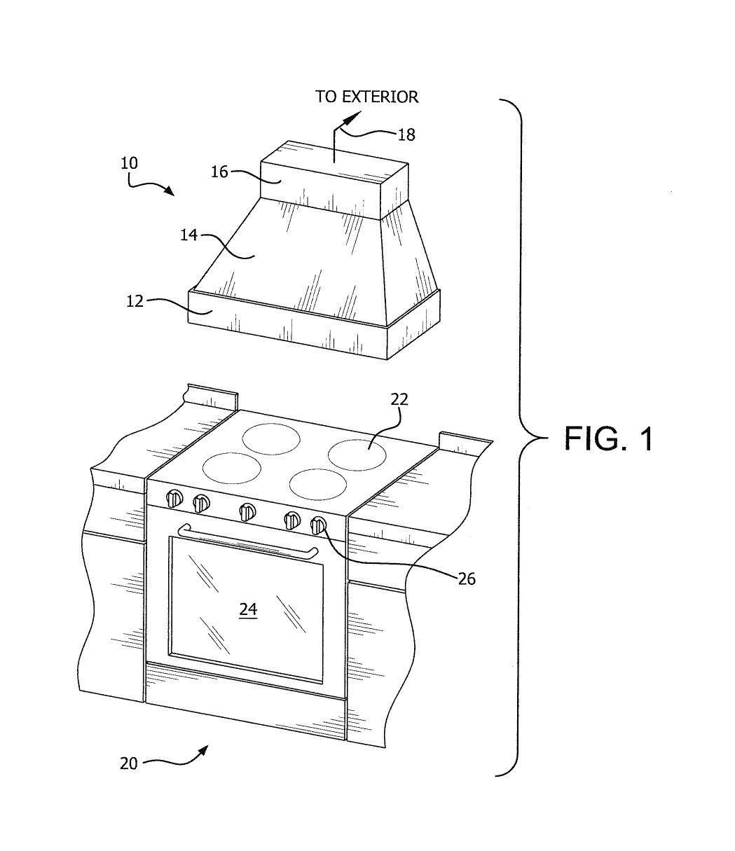

Referring to the drawings, and initially to FIG. 1, a ventilator hood indicated generally by the reference numeral 10 is mounted on a building wall. The ventilator hood 10 comprises a wide, open lower end 12, a tapering middle part 14, and a narrower top part 16. The top part 16 of the hood 10 is connected by ducting 18 (not shown in detail) to the exterior of the building. The hood 10 may be made of wood, or other decorative material.

Below the hood is a cooking stove or range indicated generally by the reference numeral 20. The stove 20 may include one or more grates or hot plates 22, an oven 24, and appropriate controls 26.

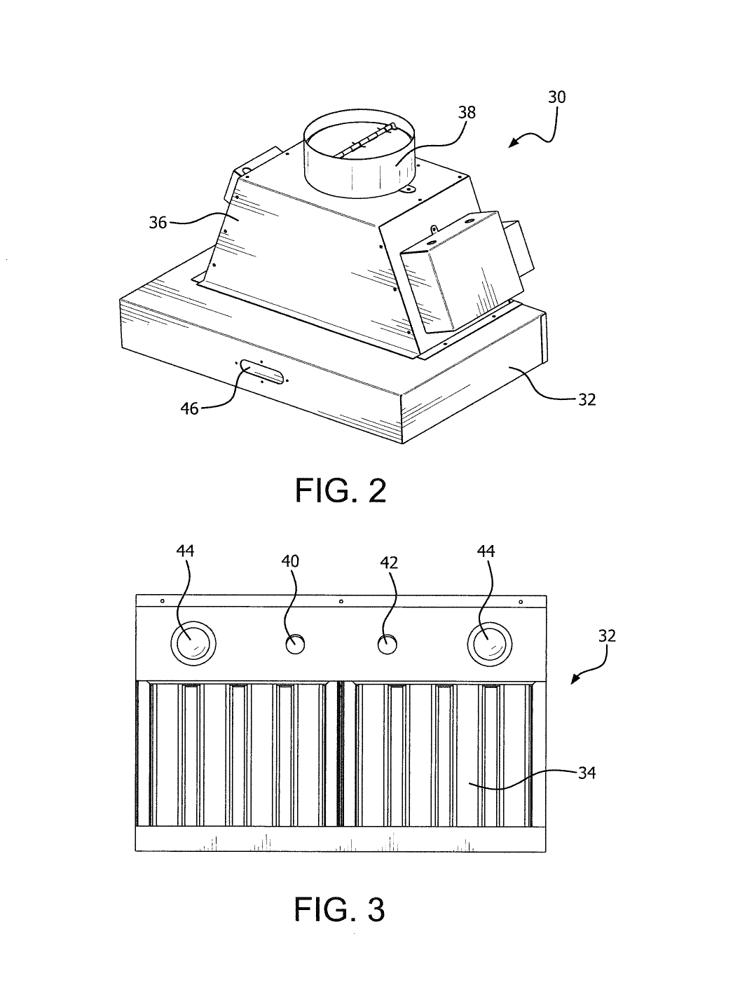

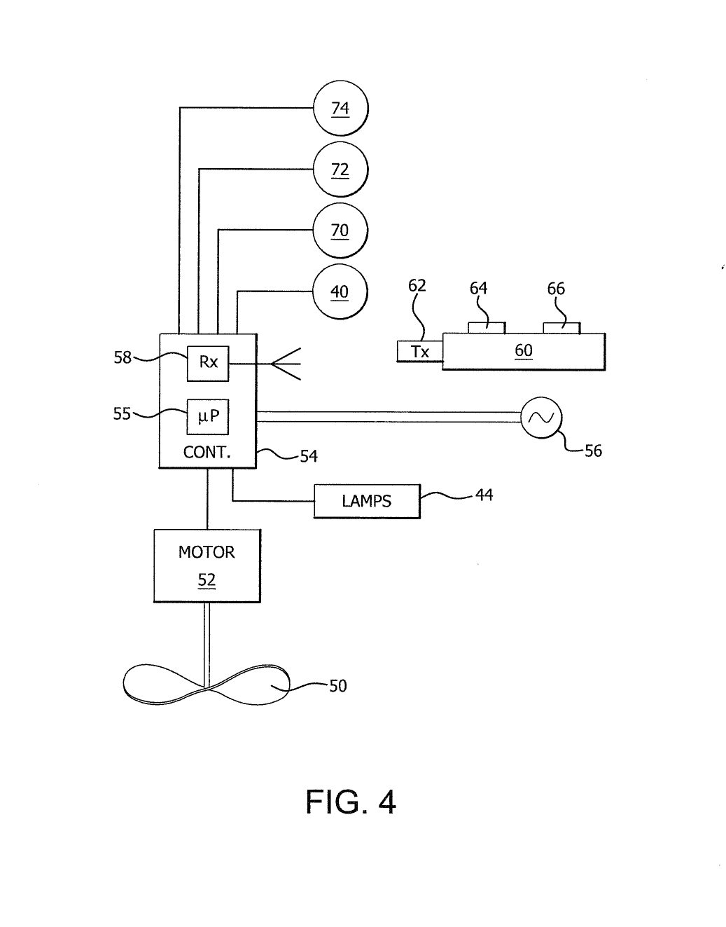

Referring now also to FIGS. 2 and 3, mounted within the hood 10 is a ventilator indicated generally by the reference numeral 30. The ventilator 30 has a lower part 32 dimensioned to fit within the lower part 12 of the hood 10, including a filter 34 for capturing particulates entrapped in the air as it is drawn in from below. The ventilator 30 has an upper part 36, including a fan (see FIG. 4) that in operation draws air in from below through the filter 34 and expels air upwards through an outlet 38 that connects to the ducting 18.

The hood 10 can be made in various sizes, some of which are more or less standard. The external dimensions of the ventilator 30 may be chosen to fit within the smallest hood size available. The ventilator 30 may then be provided with additional or adjustable mounting brackets or other components to fit larger sizes of hood 10. For example, if the internal dimensions of the lower part 12 of the hood 10 are larger than, and/or a different shape from, the external dimensions of the lower part 32 of the ventilator 30, suitable blanking plates may be provided to close off the space between the ventilator 30 and the hood 10.

On the underside of the ventilator 30 there are lights 44 for illuminating the cooktop of the stove 20. In the illustrated embodiment the underside of the ventilator 30 also includes control knobs or switches 40, 42 for controlling the fan and the lights. Of course it should be readily understood that the control switches may be placed at any suitably accessible location, such as a front surface of the hood 10. The switches could be toggles, slides, or depression switches.

The housing of the ventilator 30 is preferably made of suitable material for accommodating the temperatures and conditions that are expected, such as stainless steel, which is strong, reasonably economical, and easy to keep clean. On the front of the lower part of the ventilator 30 there is provided a window 46 to permit wireless signals to reach a sensor (see FIG. 4) inside the ventilator 30. Where the hood 10 is made of wood, and the wireless signals are radio signals, the signals can pass through the wood, so it is not necessary to provide a window in the hood. That has the aesthetic advantage that there is no visible window. If the hood is made of a material opaque to radio signals, or if the wireless signals are infrared light signals that cannot pass through wood, then a window in the lower part 12 of the hood 10 in front of the window 46 may be necessary.

Referring now also to FIG. 4, the fan 50 that draws air out through the ventilator 30 is powered by a motor 52. The motor 52 speed is powered through a controller 54 under control of a microprocessor 55 from an electrical source 56, which may be the ordinary building wiring. The controller 54 can control the speed of the motor 52 in any appropriate manner depending on the type of motor 52 being used. Various types of electric motors and various ways of controlling the speed of an electric motor are well known. In an embodiment, the controller 54 is a thyristor controller that varies the duty cycle of the electric current supplied from the source 56.

The controller 54 receives inputs from one of the control knobs 40 on the underside of the ventilator 30, and/or from a wireless receiver 58 behind the window 46. If the control knob is a rotary knob, it has a sensor that detects rotation of the control knob and signals to the controller 54 the amount and direction of rotation. Suitable rotary sensors are well known, and in the interests of conciseness will not be described in detail. The controller 54 receives signals indicating the rotation of the control knob 40, and interprets the direction of rotation as indicating whether to increase or decrease the speed of the fan, and the amount of rotation as indicating how much to increase or decrease the speed. Thus, the physical position of the rotary knob preferably does not determine fan speed desired, but the change and direction in the rotary position determines how the speed should be adjusted. In one embodiment, the knob is a rotary pulse generator with two pulse signals out (quadrature). This type of pulse generator permits the direction of rotation to be easily determined as well as the pulse rate. The microcontroller monitors these signals to determine the change in lighting level and fan speed being requested by the user.

The controller 54 is also configured to receive signals from the wireless receiver 58, which, in turn, is arranged so as to receive signals from a remote transmitter 62 on a portable remote control 60. The remote control 60 has a control switch that enables a user to input, in any convenient way, commands to increase or decrease the speed of the fan 50 by a desired amount. In an embodiment, the controller 54 can set the fan 50 to five different speeds, with the lowest speed being “off.” The remote control 60 would include an associated control switch 64, such as a knob, slide, toggle or depression switch, for example, that allows the user to enter the desired fan speed, or the desired change in the fan speed, similar to the controls on the hood 10.

If radio control is used, the remote transmitter 62 is a radio wave transmitter configured to transmit the control commands inputted into the remote control 60 to the wireless receiver 58. Use of radio waves permits the fan 50 to be controlled within the range of the radio wave transmission, which could be from anywhere within a typical house, without requiring a direct line of sight from the transmitter 62 and the receiver 58. The transmitter 62 can be a low power transmitter, similar in power output to those used in a wireless doorbell.

Other inputs into the controller 54 may also be provided. For example, a thermistor or other temperature sensor 70 may be provided on the underside of the ventilator 30. The microprocessor 55 may be programmed to turn on the fan 50 if the temperature in the lower section 32 of the ventilator exceeds a preset temperature. That provides a useful improvement in functionality and safety, because the ventilator 30 will start up automatically if the user forgets to turn on the fan 50 when using the stove 20, and heat builds up. It also protects the ventilator 30 itself from heat damage. The controller 54 (i.e., the microprocessor) can also be programmed to automatically turn off the fan when the temperature falls below a certain threshold, indicating that the overheating is no longer an issue.

It is also contemplated that a smoke detector 72 may also be provided on the underside of the ventilator 30. The microprocessor 55 may then be programmed to turn on the fan 55 if levels of smoke exceed a preset level and turn off the fan when the smoke falls below a certain level. The microprocessor programming could be such that the shut-off based on the signal from the smoke detector (i.e., the level of smoke has dissipated) may override the other inputs to the controller (i.e., the manual “on” input from the user). It is further contemplated that the amount of smoke that is detected could be used to vary the speed of the fan. For example, if there is excessive smoke, the controller may turn the fan onto its highest setting and then gradually reduce the fan speed as the smoke dissipates.

The remote control 60 may also include a lighting control switch 66 for controlling the lights 44. The signal from the switch 66 is sent by the transmitter 62 to the receiver 58 and directed to the microprocessor 55 for controlling the lights 44. The microprocessor 55 may be programmed to control the light so as to provide distinct levels of output (e.g., low, medium, bright), or could be controlled so as to provides a varying light output through a dimmer control.

In use, the controller 54, including the microprocessor 55, is connected to the power supply 56. The microprocessor 55 may then enter a “sleep” or “standby” mode, in which it monitors its inputs for control signals from the control knob/switch 40, the receiver 58, and any other sensors. When the user decides to start cooking, the user may operate either the control knob/switch 40 or the remote control 60 to turn on the fan 50 at a desired speed. While the fan is running, the user may operate either the control knob 40 or the remote control 60 to change the speed of the fan as desired, overriding the command previously provided by either of the controls (e.g., the input from the remote control 60 will override the prior input from the stationary control knob 40, and vice-versa.) When the user has finished cooking, the user may operate either the control knob 40 or the remote control 60 to turn off the fan 50. The user may choose to leave the fan running for a time after finishing cooking, and may then later turn off the fan 50 using the remote control 60, without needing to return to the stove 20. It is also contemplated that the microcontroller 55 can be programmed with a “delay off” timer, under which the fan runs at low speed for a preset time, for example, 3 minutes or 5 minutes, to cool down the air over the stove after the stove has been shut down, and then the fan shuts off. The “delay off” function may be selectable by the user, for example, by pressing an additional button 64 on the remote control. Similar functionality can be incorporated into the microprocessor 55 (or the remote 60) so as to permit the lights to be controlled so that they turn off after or at a prescribed time.

If the user does not manually turn on the fan, additional sensors such as thermistor 70 or smoke detector 72 may detect a condition under which it is desirable to use the fan, and the microprocessor 55 may then automatically activate the fan at an appropriate speed. Similarly, if the user manually turned on the fan but at too low a speed, the microprocessor 55 may override the user setting and increase the speed automatically in response to inputs from sensors such as thermistor 70 or smoke detector 72.

A light sensor 74 could be installed in the ventilator 30 that senses the ambient light in the area around the unit. When the sensed ambient light falls below a threshold level, a signal can be sent to the microprocessor 55 to turn the lights 44 on. Similarly, when the sensed ambient light rises above a threshold level, a signal can be sent to the microprocessor 55 to turn the lights 44 off.

Because the signals from control knob 40 and control switch 64 are interpreted as commanding a direction and amount of change of the fan speed, and not as setting an absolute speed, there is no difficulty in interpreting successive commands from different inputs. The microprocessor 55 saves the current speed in the memory, and increases or decreases that speed in response to subsequent inputs. When an automatic process (for example, in response to excessive smoke or heat) overrides the manual setting, the microprocessor 55 may save the last user-selected speed in the memory, and may return to that speed when the override condition no longer applies. Because the position of, for example, control knob 40 does not represent an absolute fan speed, there is no discrepancy between the knob position and the fan speed when the speed is changed by a different control or process.

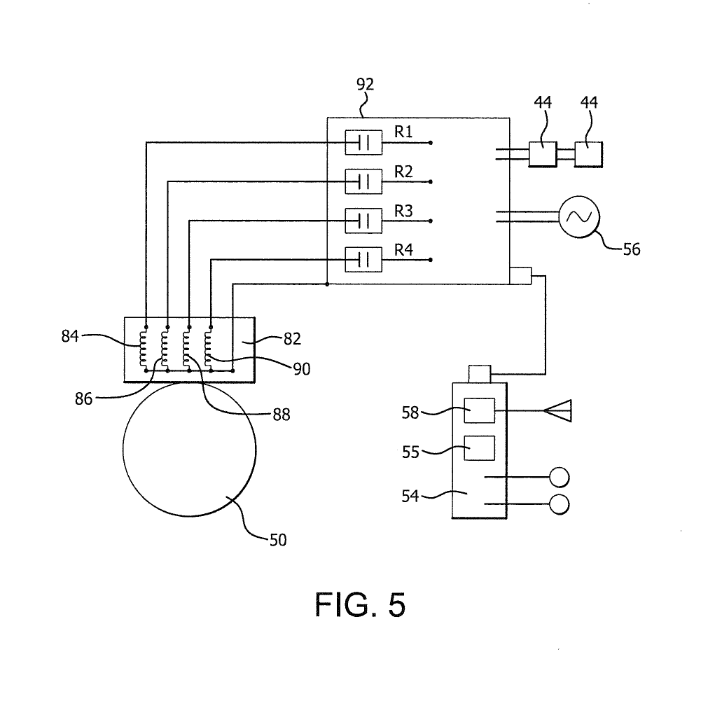

Referring now to FIG. 5, an alternative embodiment of the ventilator 30 has a motor 82 with multiple windings 84, 86, 88, 90, and is so constructed that energizing different windings causes the motor 82, and therefore the fan 50, to run at different speeds. The windings 84, 86, 88, 90 are supplied with power from the source 56 through relays R1, R2, R3, R4 in a relay unit 92. The relay unit 92 is controlled from the controller 54. The remainder of the embodiment shown in FIG. 5 may be similar to the embodiments previously described, and in the interests of conciseness, the description is not repeated.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

For example, the lower part 12 of the hood 10 and the lower part 30 of the ventilator 30 have been shown as being rectangular in plan view. Other shapes are, of course, possible. For example, where the hood 10 projects from the front of a row of cabinets, the part of the hood that projects may have additional reinforcing on the inside, so that the actual opening at the bottom of the hood 10 is T-shaped and not rectangular. In that case, the lower part 32 of ventilator 30 may be provided with matching blanking plates, to give the ventilator a T-shape that fits the opening in the hood 10.

The hood 10 shown in FIG. 1 is mounted on the vertical wall, and has a flat rear side to place against the wall. If the stove 20 is installed as an island in the middle of a kitchen, then the hood 10 will typically be mounted to the ceiling directly above the stove, and will typically be tapered from bottom to top on all sides. In such a version, it may be desirable to include remote control sensor receivers on more than one side if the transmitter is an IR signal instead of a radio signal. Similarly, additional control knobs 40 may be installed.

In an alternative configuration, the hood 10 exhausts within the kitchen, and the air is passed through a filter (commonly including activated carbon) that removes at least a significant part of the cooking smells.

In the described embodiment, the wireless remote control 60 and receiver 58 are a radio transmitter and receiver. Various advantages of that feature have been explained. However, other forms of communication are possible, including infrared light. Infrared signaling may be preferred if for any reason it is desired to restrict wireless communication to line of sight, or if radio communication is unavailable under local regulations or because of interference from other transmitters.

In the described embodiment, the wireless remote control 60 is a dedicated control for the ventilator 30. Other arrangements are possible. For example, the receiver 58 could be a Bluetooth or other generic receiver, and the remote control 60 could be a corresponding generic transmitter tied to the specific receiver. For example, the remote control 60 could then be a smartphone with a Bluetooth transmitter, running an app that provides a user interface to control the ventilator 30.

In the interests of simplicity, one stationary control knob 40 and one remote control 60 have been illustrated. As mentioned above, additional control knobs 40 could be provided if it is convenient to be able to control the fan 50 from more than one location around the stove 20. Additional remote controls 60 could also be provided, which may use the same or different forms of wireless communication provided that the appropriate receiver or receivers 58 are provided.

The system or systems described herein may be implemented on any form of microprocessor. The system of the present invention may include a software program stored on the microprocessor and/or storage device (e.g., mediums). The method may be implemented through program code or program modules stored on a non-volatile computer-readable storage medium.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail.

Finally, the use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

Accordingly, reference should be made to the appended claims, rather than to the foregoing specification, as indicating the scope of the invention.

1. A ventilator for a hood over a stove, comprising:
a fan;
a controller that is operative to regulate a speed of the fan;
a receiver that is operative to receive wireless signals and to provide a first signal providing information from a received wireless signal as a first input to the controller;
a manipulable control that is operative to provide a second signal indicative of manipulation of the control as a second input to the controller;
wherein in operation the controller monitors the first and second inputs, and if the first or second signal is received, increases or decreases the speed of the fan.

2. The ventilator of claim 1, wherein the controller is programmed to interpret each of the first and second signals as indicating whether to increase or decrease the speed of the fan, and how far to change the speed of the fan.

3. The ventilator of claim 2, wherein the controller is programmed to respond to either the first or the second signal irrespective of whether its previous state was set by the first signal or the second signal.

4. The ventilator of claim 1, further comprising one or more environmental sensors, and wherein the controller is programmed to respond to predetermined environmental conditions by setting the fan to a speed that overrides a speed set in response to the first or second signal.

5. The ventilator of claim 1, wherein the controller is programmed to set the fan to one of an off state and a plurality of speeds other than the off state.

6. The ventilator of claim 1, wherein the controller includes a microprocessor.

7. The ventilator of claim 1, wherein the wireless signals are radio signals.

8. The ventilator of claim 1, wherein the manipulable control is a rotatable control knob with a rotary encoder operative to provide the second input indicating a sense in which the knob is rotated and how far the knob is rotated.

9. The ventilator of claim 1, further comprising a remote control operative to transmit the wireless signals that can be received by the wireless receiver.

10. The ventilator of claim 9, further comprising lighting for illuminating an area below the ventilator, and wherein the remote control is operative to transmit, and the wireless receiver is operative to receive, commands to control the lighting.

11. The ventilator of claim 1, in combination with a hood arranged to be mounted over a stove, wherein the ventilator is dimensioned to be mounted within the hood, with an air intake of the ventilator being positioned within an open lower end of the hood and an air outlet of the ventilator connectable to an exhaust duct leading through an upper end of the hood.

12. The ventilator of claim 11, wherein the hood is permeable to the wireless signals.

13. The ventilator of claim 1, further comprising a metal housing, wherein the wireless receiver is within the housing, and the housing has a window of material permeable to the wireless signals but not permeable to air.

14. A control system for controlling operation of a ventilator for a hood over a stove, the ventilator including a fan, the control system comprising:
a controller that is operative to regulate an operating speed of the fan;
a wireless receiver operative to receive a wireless signal from a remote controller, and to provide a first signal to the controller indicative of the wireless signal;
a manipulable input control operative to provide a second signal to the controller, the second signal being indicative of manipulation of the input control;
the controller programmed to receive the first and second signals, and to change the speed of the fan upon receiving the first or second signal.

15. The ventilator of claim 1, wherein the manipulable control is a rotary knob connect to a pulse generator such that rotation of the knob emits pulses as the second signal, and wherein the controller is a microcontroller which received the first input and determines the pulse rate and direction therefrom.
